(19) United States
(12) Patent Application Publication
(10) Pub. No.: US 2010/0304793 A1
(43) Pub. Date: Dec. 2, 2010

(54) MOBILE DEVICE HAVING TWO TOUCH SCREEN DISPLAY PANELS

(76) Inventors: Chong-Sok Kim, Seongnam-si (KR); Sungjoon Stephen Cho, Seoul (KR)

Correspondence Address: F. CHAU & ASSOCIATES, LLC, 130 WOODBURY ROAD, WOODBURY, NY, 11797, US

(21) Appl. No.: 12/779,269

(22) Filed: May 13, 2010

(30) Foreign Application Priority Data
May 29, 2009 (KR) 10-2009-0047272

(51) Int. Cl. H04B 1/38; G06F 3/041; G06F 3/02

(52) U.S. Cl. 455/566; 345/173; 345/169

(57) ABSTRACT

A mobile device having two touch screen display panels includes a first body, a first touch screen disposed on an upper portion of the first body, a second body disposed under the first body, and a second touch screen disposed on an upper portion of the second body. The mobile device is configured to operate in a full-screen mode. In the full-screen mode, the first body is configured to slide in a first direction and a second direction, perpendicular to the first direction, such that the first and second touch screens are adjacent, form a substantially level surface, and function as a single display area.

### CROSS-REFERENCE TO RELATED APPLICATIONS

This application claims the benefit of Korean Patent Application No. 10-2009-0047272, filed on May 29, 2009, in the Korean Intellectual Property Office, the disclosure of which is incorporated by reference herein in its entirety.

### BACKGROUND

The inventive concept relates to a mobile device, and more particularly, to a mobile device having two touch screen display panels capable of operating in three modes.

Touch screen display panels have been employed in numerous mobile devices. Generally, a mobile device includes only one touch screen display panel. When a mobile device has only one touch screen display panel, the display panel is divided into a plurality of sub-areas and different functions are respectively assigned to the sub-areas. As a result, the area of the touch screen display panel used for displaying an image is limited. For example, when inputting text on a mobile device having only one touch screen display panel, a particular area of the display panel functions as an on-screen keyboard and the remaining area of the display panel functions as an actual display area. Thus, a mobile device having only one touch screen display panel typically has a smaller display area than a mobile device having a dedicated physical keyboard.

A slide type mobile device is a type of mobile device having an upper panel that functions as a touch screen display panel and a lower panel that functions as a dedicated physical keyboard. Because the slide type mobile device only has one touch screen display panel, the display area for the device is also limited.

A folder type mobile device is a type of mobile device having a touch screen display panel on each of a lower portion of an upper panel and an upper portion of a lower panel. The upper panel may be unfolded 180° with respect to the lower panel, providing the user with access to both touch screen display panels. Although the folder type mobile device provides a larger display area and a larger area for user input via the two touch screen display panels, basic mobile device service functions, such as calling or message checking, are inconvenient because the mobile device must be unfolded to view the display panels and perform these basic functions.

### SUMMARY

According to an exemplary embodiment of the inventive concept, a mobile device having two touch screen display panels includes a first body, a first touch screen disposed on an upper portion of the first body, a second body disposed under the first body, and a second touch screen disposed on an upper portion of the second body. The mobile device is configured to operate in a full-screen mode. In the full-screen mode, the first body is configured to slide in a first direction and a second direction, substantially perpendicular to the first direction, such that the first and second touch screens are adjacent, form a substantially level surface, and function as a single display area.

The mobile device may be configured to operate in a first operation mode in which the first body substantially covers the second body, and only the first touch screen functions while in the first operation mode.

The mobile device may be configured to operate in a second operation mode, wherein the first body is configured to slide to an ending point such that a partial area of the second touch screen is exposed.

In the second operation mode, the first touch screen may function as a display area and the second touch screen may function as a user input area. The user input area may comprise a QWERTY keyboard. The first touch screen may further function as a game display area and the second touch screen may further function as a game input area comprising game controls.

The mobile device may further include at least one electrical line disposed on a side surface of an end portion of the first body and a lower portion of the first body, and at least one electrical groove disposed on a side surface of an end portion of the second body and the upper portion of the second body, wherein the electrical groove engages the electrical line and data is transferred between the first body and the second body via the electrical line and the electrical groove.

The first body and the second body of the mobile device may be configured to be coupled to each other using at least one of a magnetic material, a locking device, a fixing device, or a guard rail.

The mobile device may further include a hinge disposed on at least one side surface of an end portion of the second body, wherein the hinge comprises a horizontal groove and a vertical groove in a T-shape. The first body may be configured to slide in the first direction along the horizontal groove and slide in the second direction along the vertical groove.

The mobile device may further include a magnetic material formed on an outer surface of the first body, and a metal material formed on a surface of the hinge contacting the outer surface of the first body, wherein a distance between the magnetic material and the metal material is shortened as the first body slides in the first direction, and the first body stops sliding in the first direction upon alignment of the metal material and the magnetic material.

The hinge may further include a stopper hole and a stopper, wherein the stopper blocks the vertical groove and prevents the first body from sliding in the second direction until the first body slides to an ending point in the first direction, wherein the stopper enters the stopper hold and unblocks the vertical groove at the ending point.

The stopper may include a sub-stopper protruding towards the first body, wherein the sub-stopper enters a gap formed in the stopper hole upon the stopper entering the stopper hole. The sub-stopper may be attached to a spring.

According to another exemplary embodiment of the inventive concept, a method for switching operation modes of a mobile device includes sliding a first body of the mobile device in a first direction and sliding the first body of the mobile device in a second direction, substantially perpendicular to the first direction, upon the first body sliding to a first ending point in the first direction. A first touch screen disposed on an upper portion of the first body and a second touch screen disposed on an upper portion of a second body are adjacent, form a substantially level surface, and function as a single display upon the first body sliding to a second ending point in the second direction.

The method may further include transferring data between the first body and the second body via an electrical line disposed on the first body and an electrical groove disposed on the second body.

The method may further include sliding the first body in the first direction along a horizontal groove of a hinge and sliding the first body in the second direction along a vertical groove of the hinge.

### BRIEF DESCRIPTION OF THE DRAWINGS

Exemplary embodiments of the inventive concept will be more clearly understood from the following detailed description taken in conjunction with the accompanying drawings in which:

FIGS. 1A-1B show a perspective view and a side view of a mobile device having two touch screen display panels, in a first operation mode, according to an exemplary embodiment of the present inventive concept;

FIGS. 2A-2B show a perspective view and a side view of a mobile device having two touch screen display panels, in a second operation mode, according to an exemplary embodiment of the present inventive concept;

FIGS. 3A-3B show a perspective view and a side view of a mobile device having two touch screen display panels, in a third operation mode, according to an exemplary embodiment of the present inventive concept;

FIGS. 4A-4B show a perspective view and a side view illustrating the electric coupling structure of a mobile device having two touch screen display panels according to an exemplary embodiment of the present inventive concept;

FIG. 5 is a perspective view illustrating the electric coupling structure of a mobile device having two touch screen display panels, in the third operation mode, according to an exemplary embodiment of the present inventive concept;

FIG. 6 is a block diagram schematically illustrating the internal structure of a mobile device according to an exemplary embodiment of the present inventive concept;

FIGS. 7-9 are perspective views illustrating the service types of the three operation modes of a mobile device according to an exemplary embodiment of the present inventive concept; and

FIG. 10A-10D illustrate a two-way hinge utilized for switching a mobile device to a third operation mode, according to an exemplary embodiment of the present inventive concept.

### DETAILED DESCRIPTION OF THE EMBODIMENTS

The attached drawings for illustrating embodiments of the inventive concept are referred to in order to gain a sufficient understanding of the inventive concept. Hereinafter, the inventive concept will be described in detail by explaining exemplary embodiments of the inventive concept with reference to the attached drawings. Like reference numerals in the drawings denote like elements.

It will be understood that when an element is referred to as being “connected” or “coupled” to another element, it can be directly connected or coupled to the other element or intervening elements may be present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this inventive concept belongs.

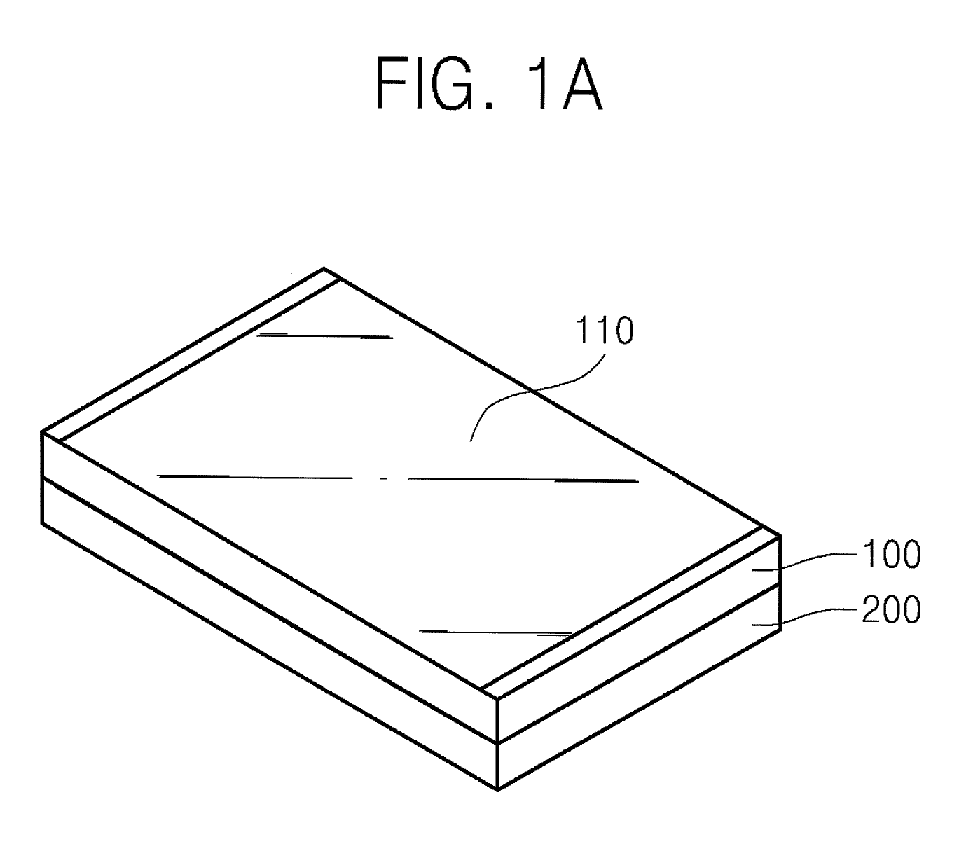

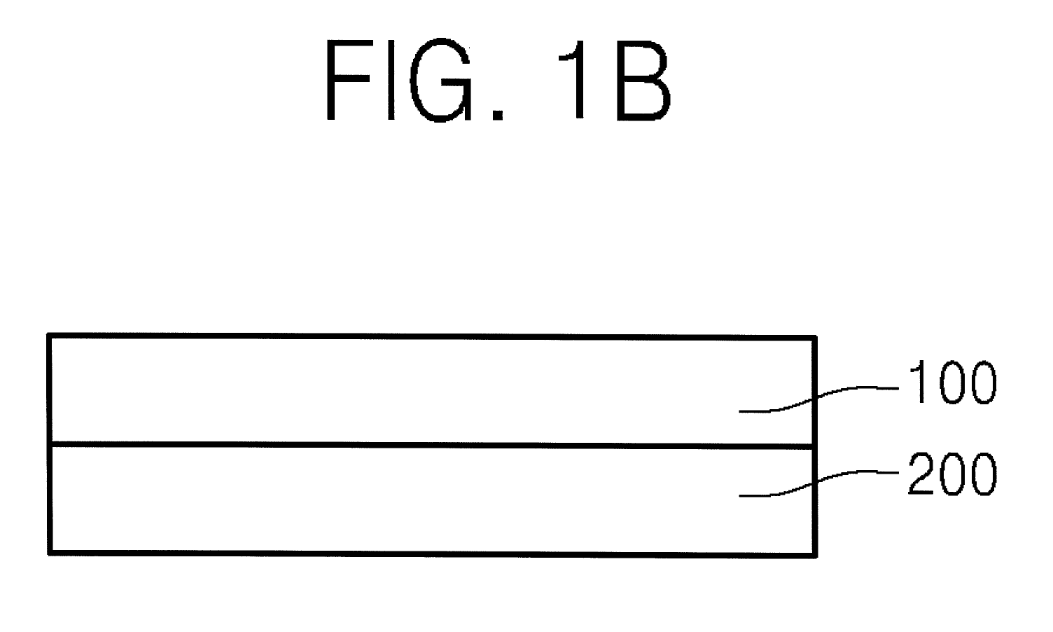

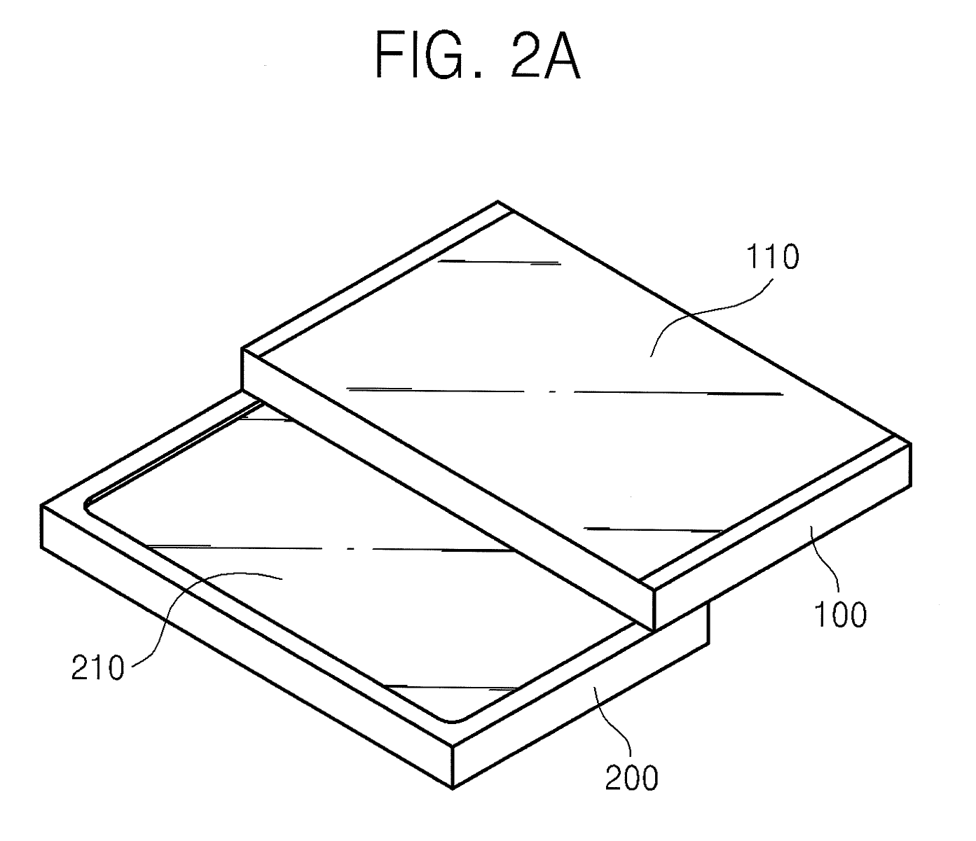

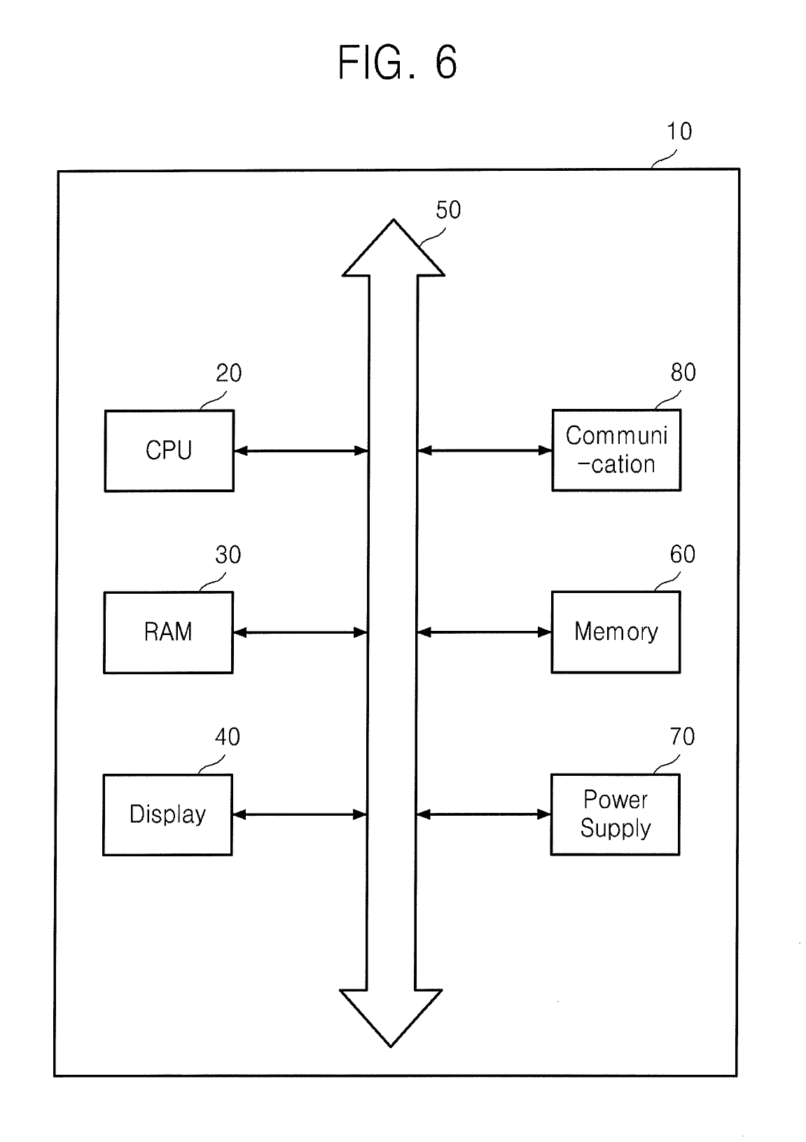

FIGS. 1-3 are perspective views and side views illustrating first to third operation modes of a mobile device having two touch screen display panels 110 and 210 (hereinafter, referred to as “touch screens”) according to an exemplary embodiment of the present inventive concept. Referring to FIGS. 1-3, the mobile device includes two bodies. For example, the mobile device includes a first body 100 forming an upper panel and a second body 200 forming a lower panel. The first body 100 includes a first touch screen 110 on an upper portion thereof, and the second body 200 includes a second touch screen 210 on an upper portion thereof. The mobile device may be operated in three operation modes. A control unit 20 of the mobile device, as shown in FIG. 6, may determine the current operation mode and provide appropriate functionality based on the current operation mode.

Referring to FIGS. 1A-1B, in the first operation mode, the lower portion of the first body 100 and the upper portion of the second body 200 are aligned such that the upper portion of the second body 200 is substantially covered by the lower portion of the first body 100. In the first operation mode, the mobile device operates as a bar type mobile device wherein only the first touch screen 110 is utilized. Accordingly, basic service functions suitable for the bar type configuration, such as, for example, general calling, message checking, menu setting, or schedule checking, may be provided.

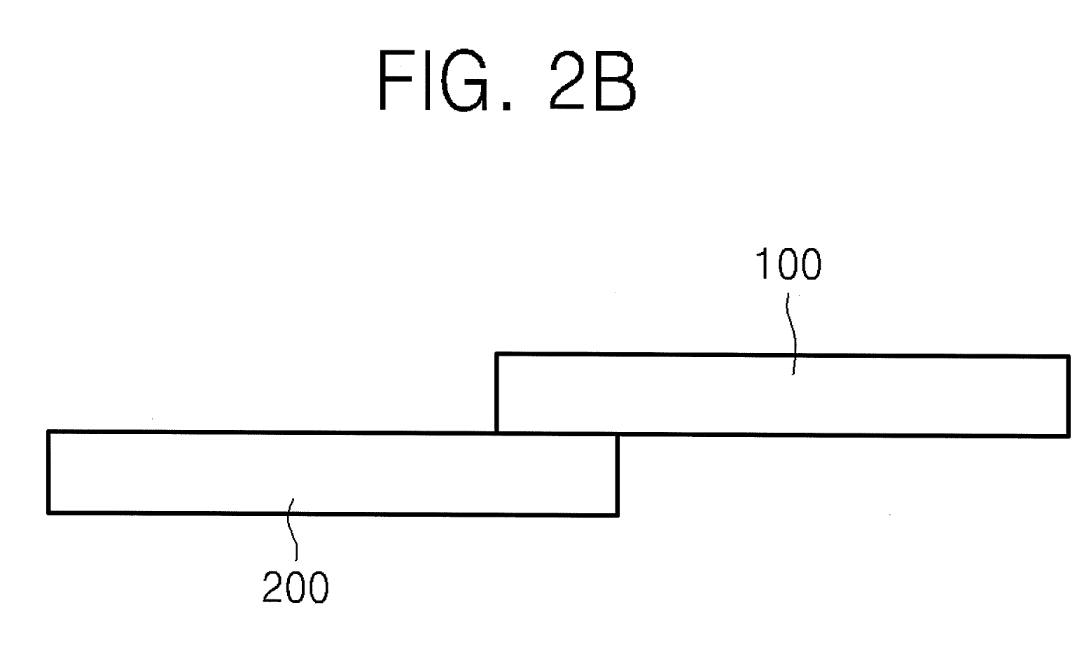

Referring to FIGS. 2A-2B, in the second operation mode, the first body 100 slides until it reaches an ending point and the upper portion of the second body 200 is partially covered by the first body 100. In the second operation mode, the first touch screen 110 of the mobile device may function as a display area and the exposed area of the second touch screen 210 may function as an input area such as, for example, a QWERTY keyboard.

Accordingly, service functions requiring text input, such as, for example, document editing, messaging, or Internet browsing, may be provided. A game function may also be provided, wherein the first touch screen 110 functions as a game display area and the exposed area of the second touch screen 210 functions as a game input area providing game controls.

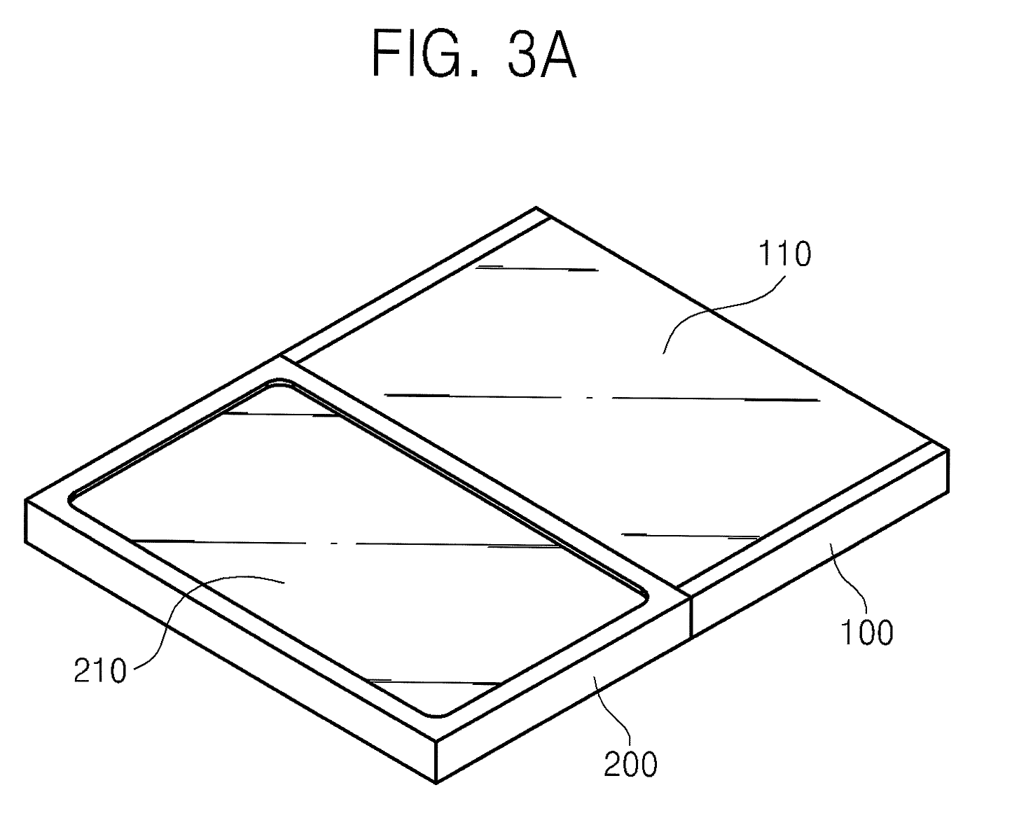

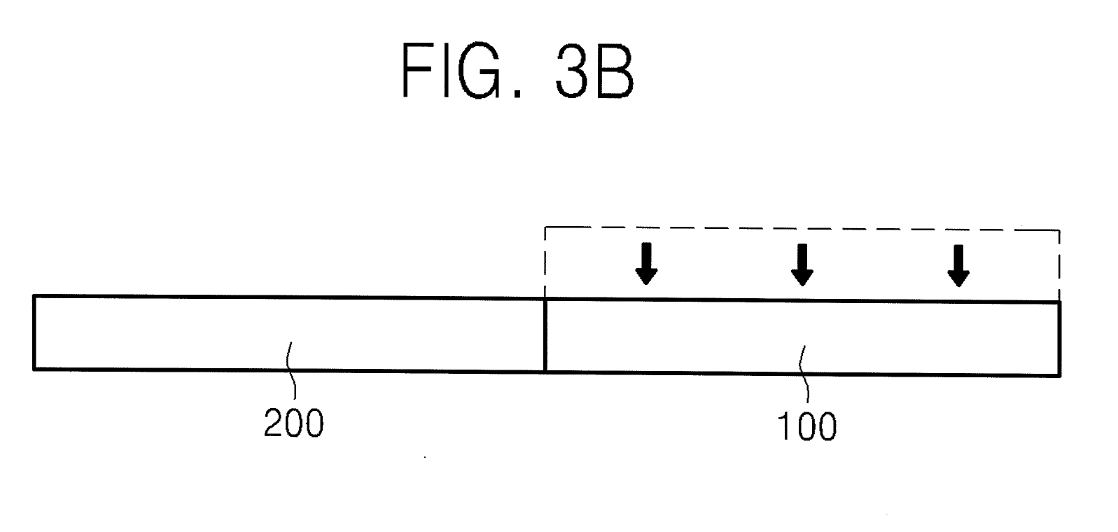

Referring to FIGS. 3A-3B, in the third operation mode (hereinafter, referred to as “full-screen mode”), the first body 100 slides in a first direction until a first ending point in the first direction is reached and the upper portion of the second body 200 is substantially exposed. The first body 100 then slides in a second direction, substantially perpendicular to the first direction, until a second ending point in the second direction is reached. For example, as the first body 100 perpendicularly slides in a downward direction, one side of the first body 100 and one side of the second body 200 align such that the first touch screen 110 and the second touch screen 210 are substantially exposed, forming a single screen on a level surface. In this case, the first touch screen 110 of the mobile device functions as a first display area of a single screen and the second touch screen 210 functions as a second display area of the single screen. The two display areas combined form one complete, continuous display area.

Although the first body 100 located above the second body 200 is horizontally moved over the second body 200 in the present exemplary embodiment (e.g., the first body 100 moves along a horizontal surface of the second body 200 and then descends perpendicularly), the second body 200 may be horizontally moved under the first body 100 (e.g., the second body 200 may move along a horizontal surface of the first body 100 and then ascend perpendicularly) in another exemplary embodiment.

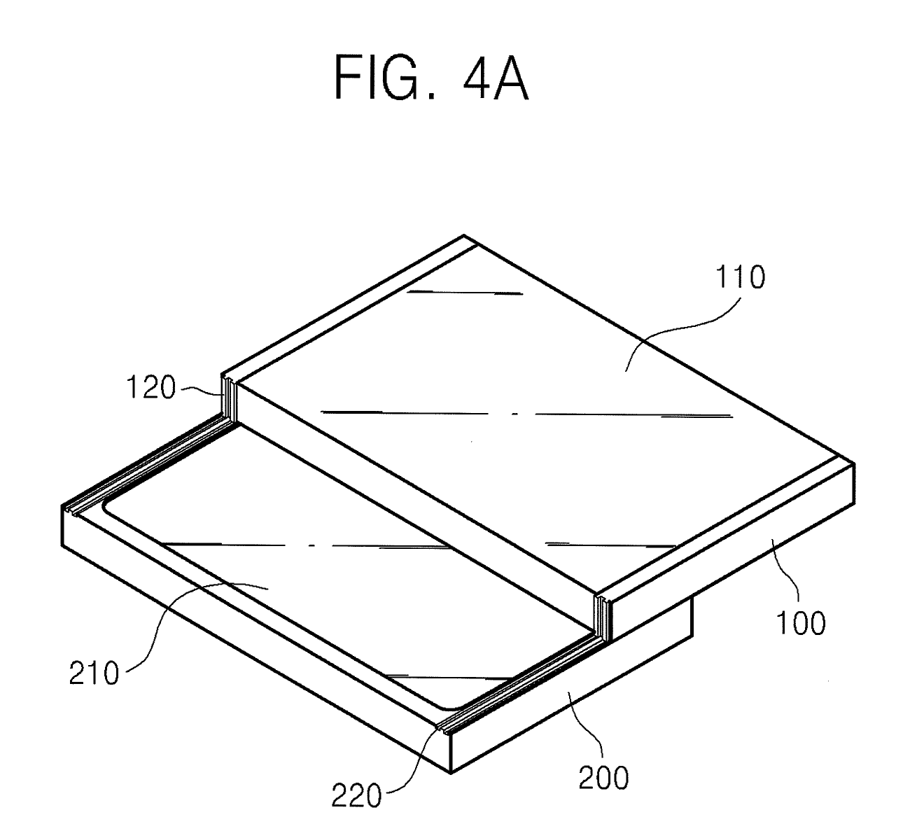

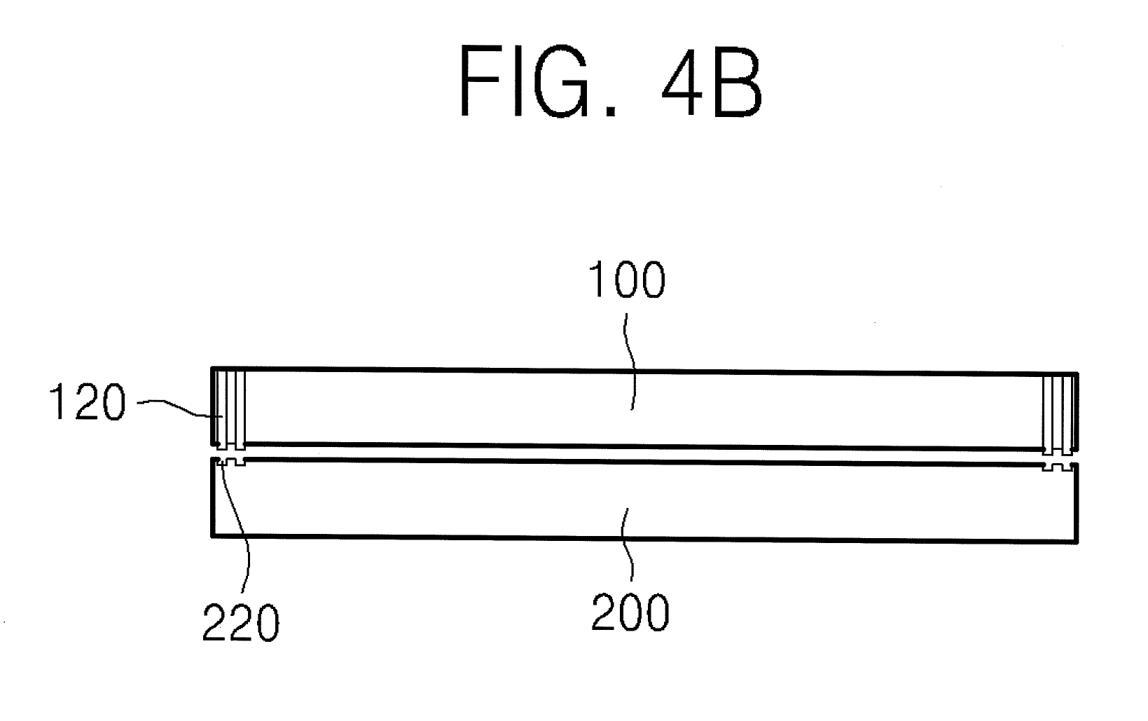

FIGS. 4A-4B show a perspective view and a side view illustrating an electric coupling structure of a mobile device having two touch screen display panels 110 and 210 according to an exemplary embodiment of the present inventive concept. Referring to FIGS. 4A-4B, the mobile device includes at least one electrical line 120 disposed on a side surface of an end portion of the first body 100 and on the lower portion of the first body 100 protruding along the sliding direction. At least one electrical groove 220, which engages the electrical line 120, is disposed on a side surface of an end portion of the second body 200 and on the upper portion of the second body 200. As the electrical line 120 contacts the electrical groove 220, data can be transferred between the first body 100 and the second body 200.

In the exemplary embodiment described above, the data transfer occurring via the electrical groove 220 and the electrical line 120 occurs in a low frequency environment that is not harmful to a human body, however the present inventive concept is not limited thereto. In another exemplary embodiment, data may be transferred between the first body 100 and the second body 200 via an electrical pin protruding from a hole on the first body 100 and a corresponding electrical receptacle formed in the second body 200. The electrical receptacle may include a cover that opens based on the positions of the first body 100 and the second body 200, allowing the electrical pin to engage the electrical receptacle.

In another exemplary embodiment of the present inventive concept, in the second operation mode, the first body 100 and the second body 200 may be electrically connected via a thin electric wire connecting an LCD device and a body in the mobile device. In another exemplary embodiment, in the third operation mode, the first body 100 and the second body 200 may be electrically connected via an electrical pin that connects a side portion of the first body 100 and a side portion of the second body 200.

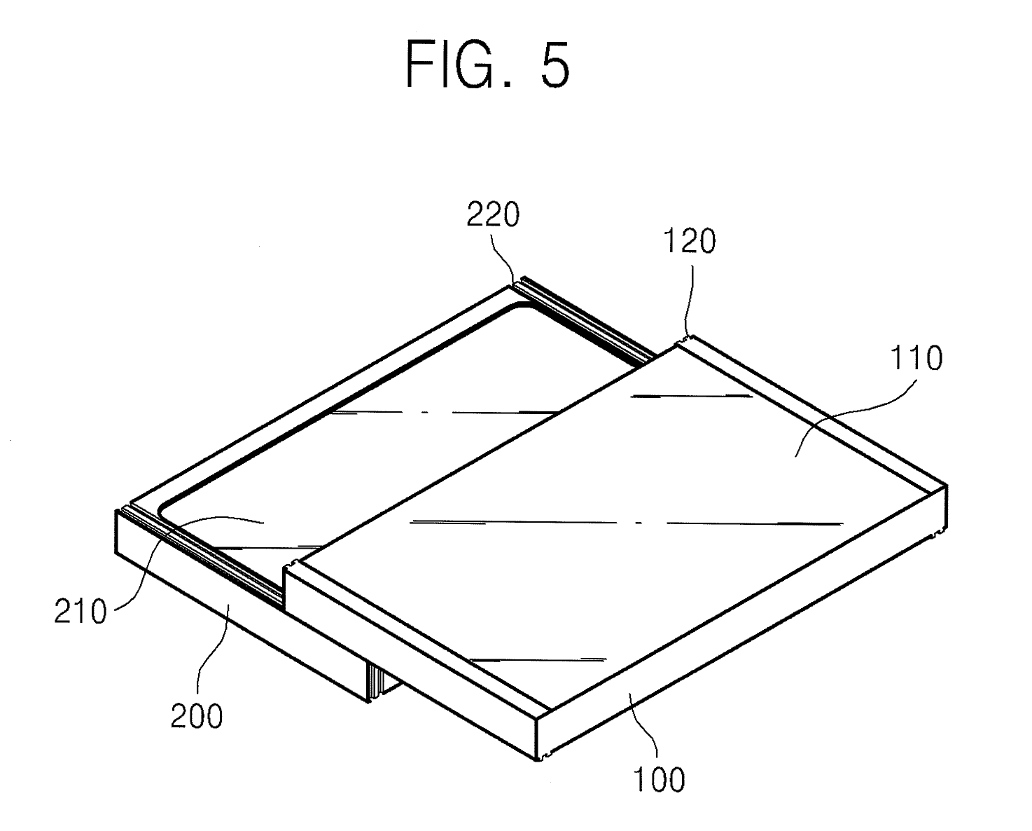

FIG. 5 is a perspective view illustrating the electric coupling structure of a mobile device having two touch screen display panels 110 and 210, in the third operation mode, according to an exemplary embodiment of the present inventive concept. Referring to FIG. 5, in the third operation mode, the electrical line 120 protrudes from a side surface of an end portion of the first body 100 and the lower portion of the first body 100. The electrical groove 220 is disposed on the side surface of an end portion of the second body 200 and in the upper portion of the second body 200. The electrical groove 220 engages the electrical line 120. As described above, the and data may be transferred between the first body 100 and the second body 200 via the connection made between the electrical line 120 and the electrical groove 220.

In the third operation mode, the first body 100 and the second body 200 may be coupled to each other using a variety of methods. For example, magnetic materials having opposite polarities may be respectively included in portions of the first body 100 and the second body 200 contacting each other. In another exemplary embodiment, a locking device or a fixing device may be disposed at portions of the first body 100 and the second body 200 contacting each other. In another exemplary embodiment, a guard rail may be disposed on both side surfaces of the first body 100 and the second body 200 such that the first body 100 horizontally slides and perpendicularly descends along the guard rail and is fixed to the second body 200.

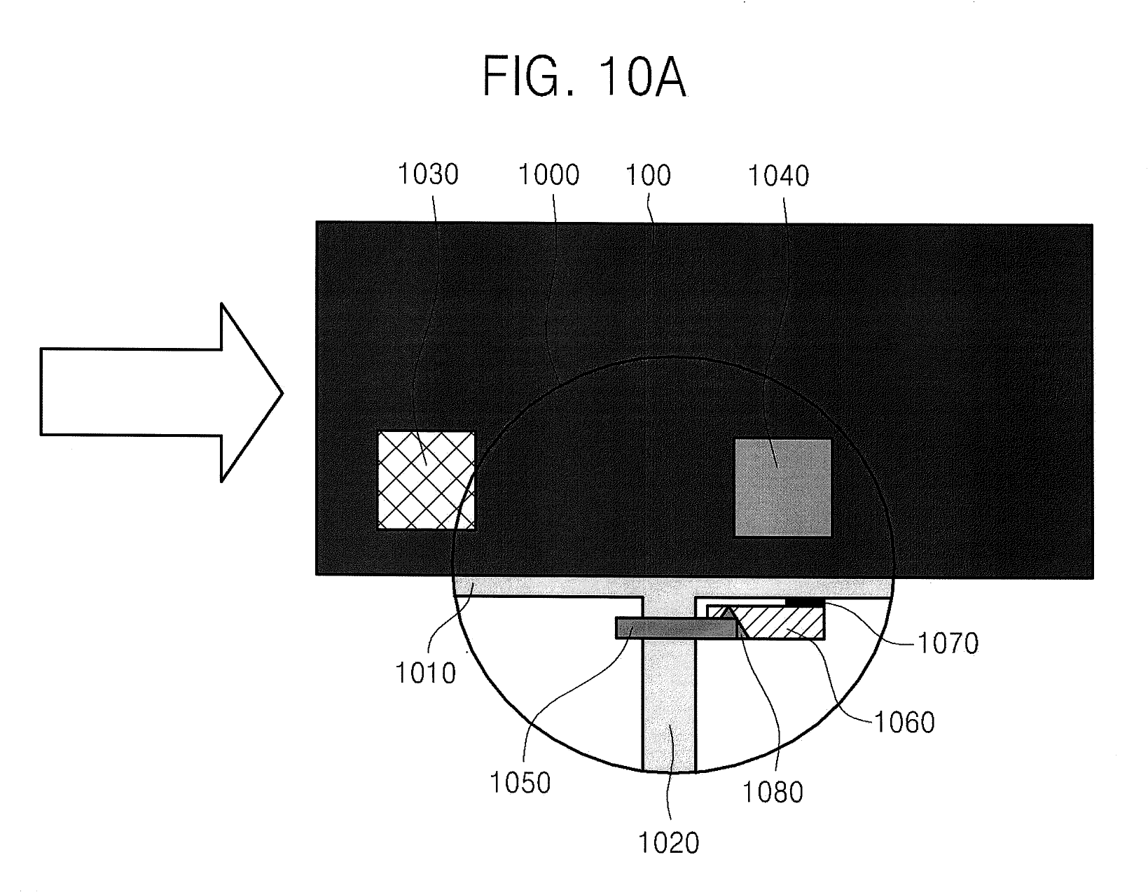

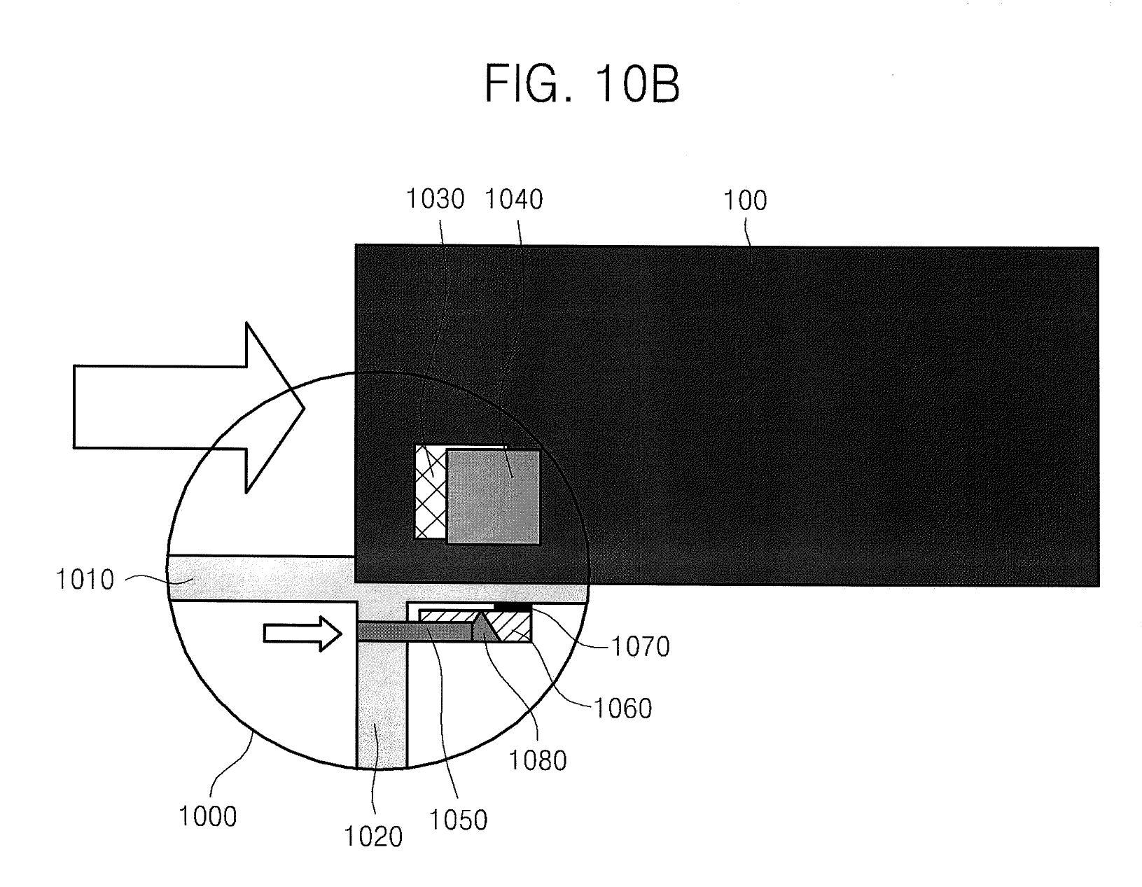

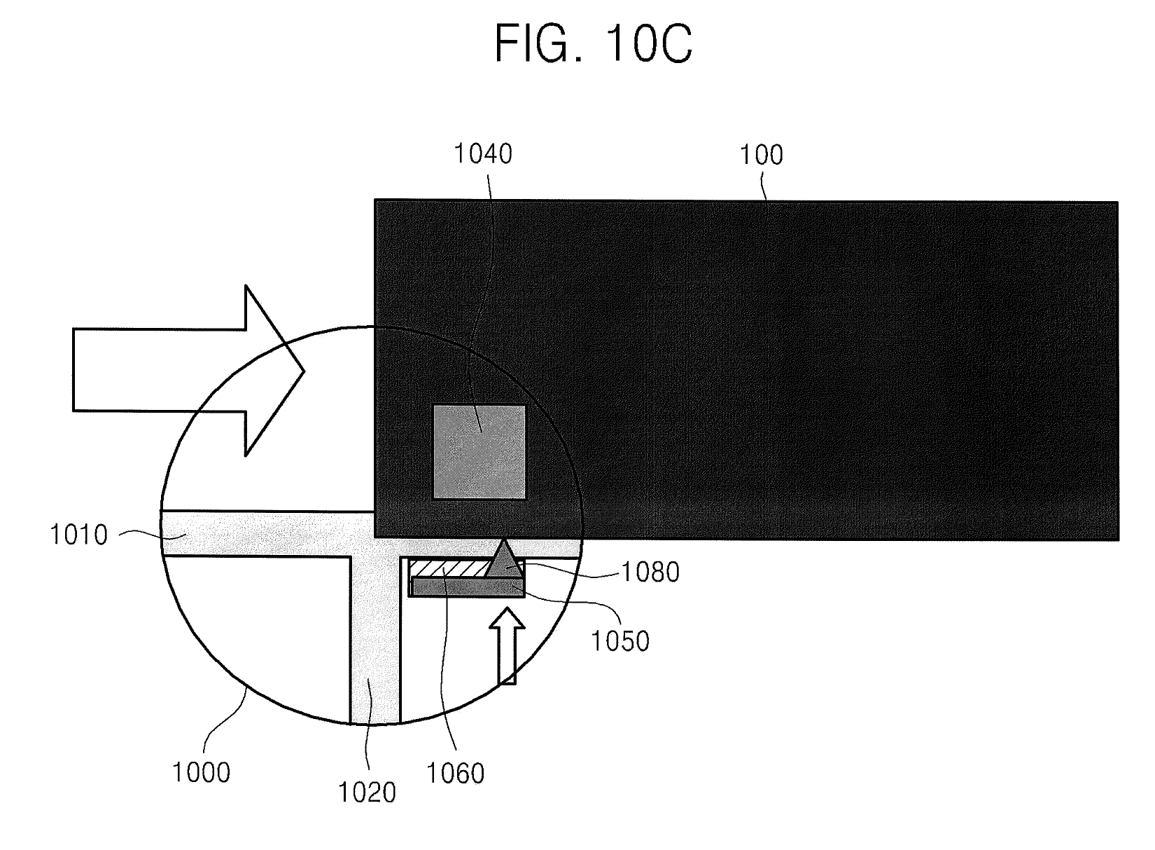

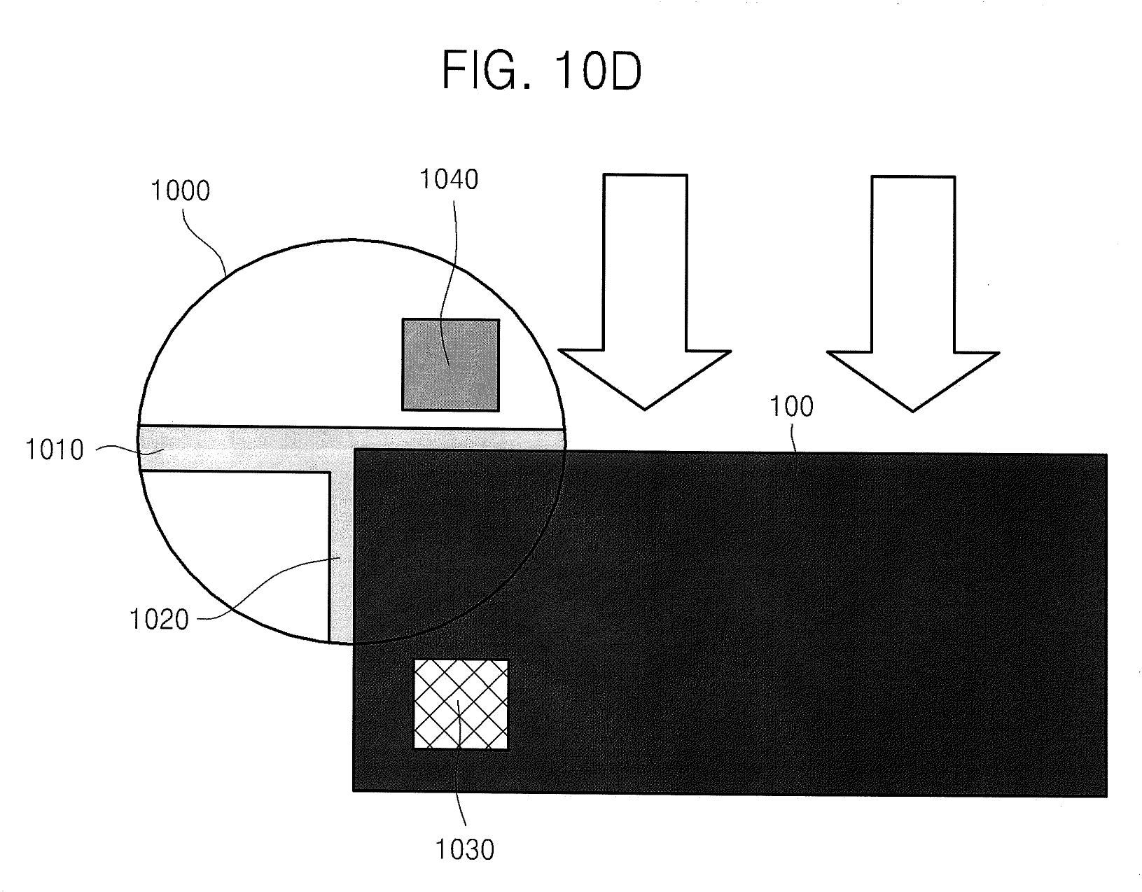

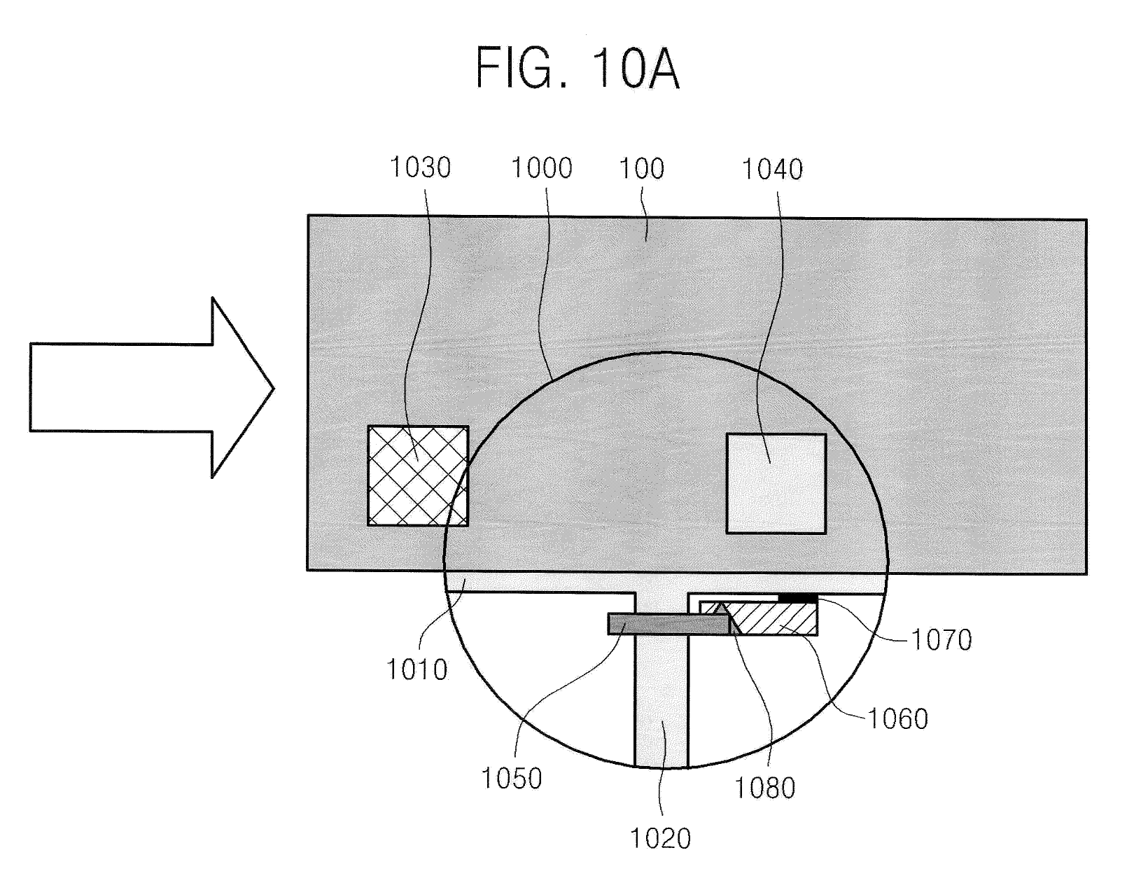

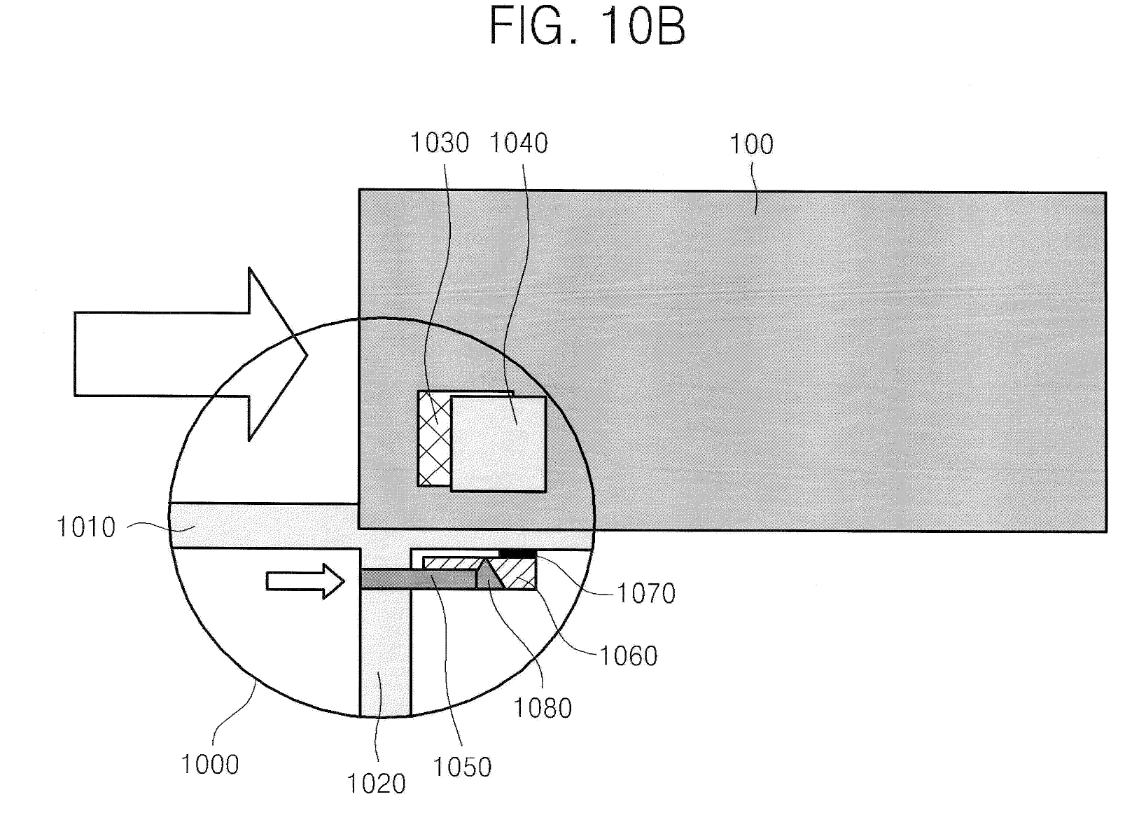

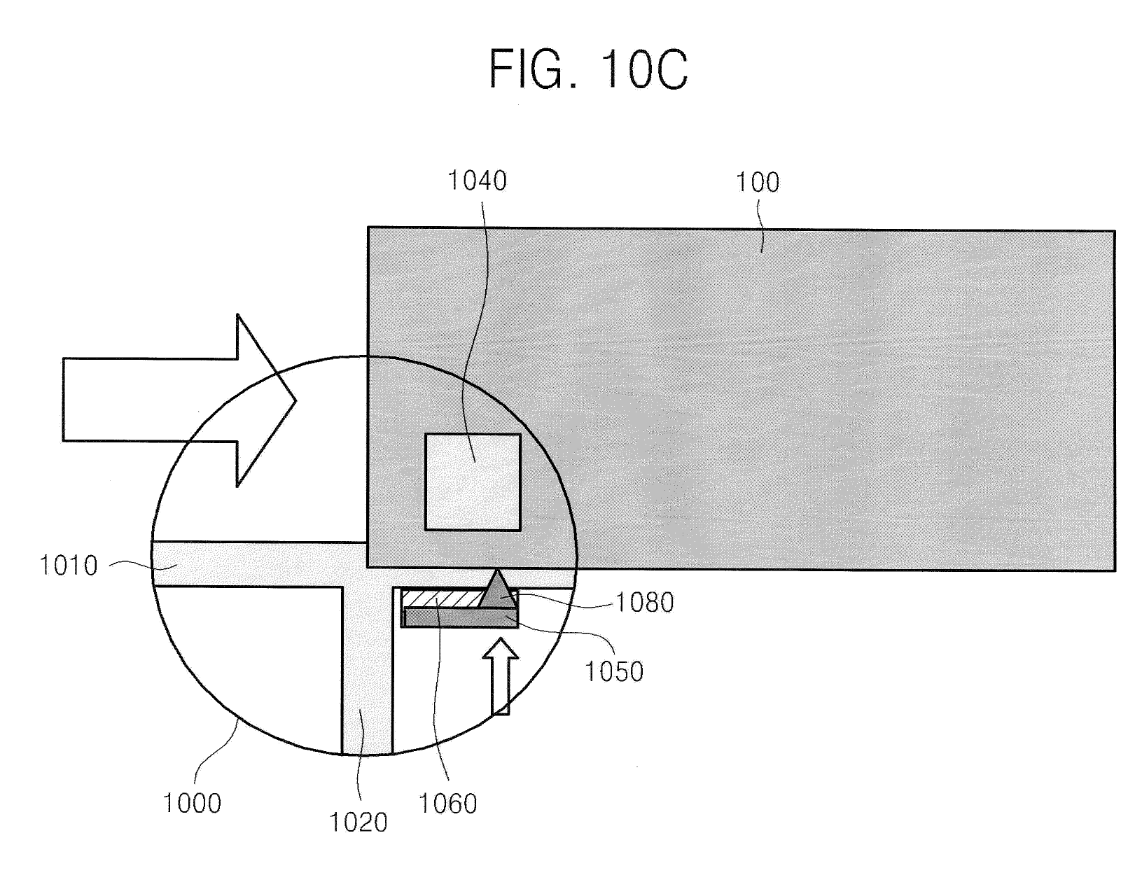

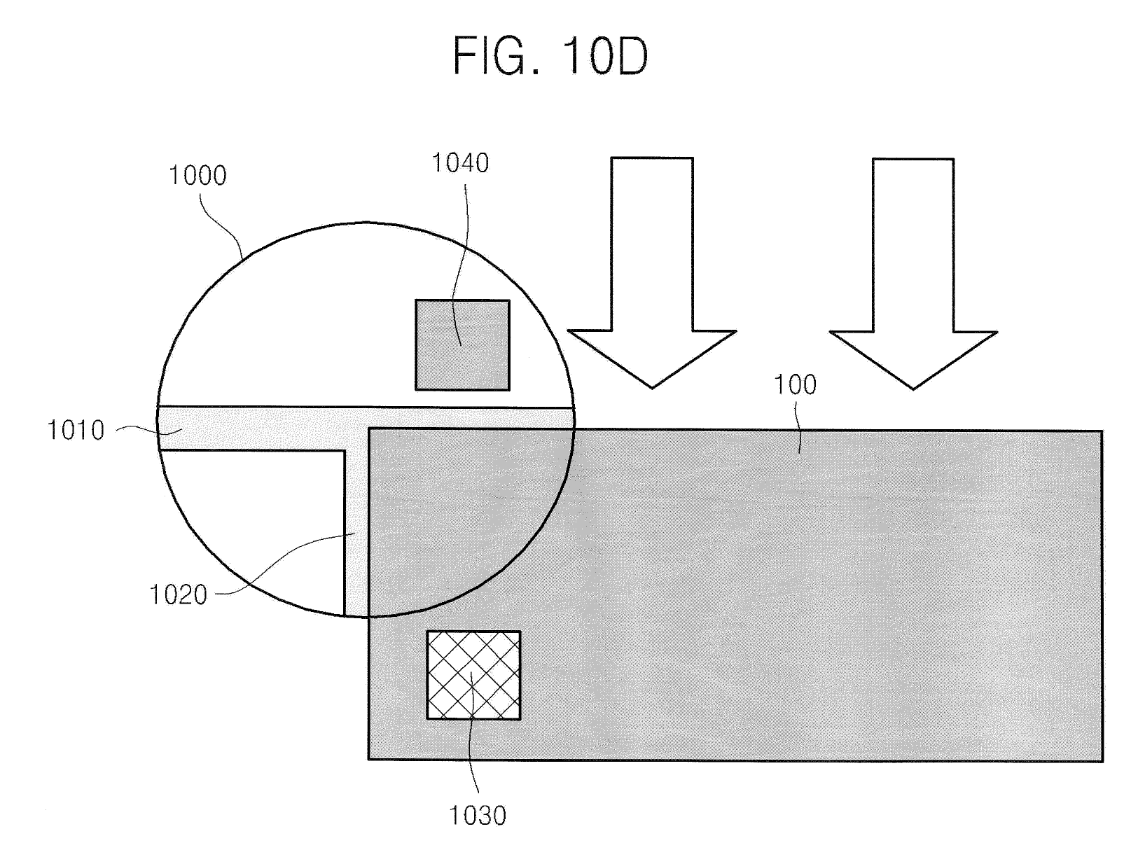

FIGS. 10A-10D illustrate a two-way hinge 1000 utilized by the mobile device to switch to the third operation mode, according to an exemplary embodiment of the present inventive concept. Referring to FIGS. 10A-10D, the two-way hinge 1000 may be disposed on at least one of the side surfaces of an end portion of the second body 200. The two-way hinge 1000 includes a horizontal groove 1010 and a vertical groove 1020. The horizontal and vertical grooves 1010 and 1020 may form a T-shape and support the horizontal and vertical movement of the first body 100 in the third operation mode. In this exemplary embodiment, the first body 100 slides along the horizontal groove 1010 and descends along the vertical groove 1020, such that the first body is adjacent and level with the second body 200, and the first and second touch screens 110 and 210 form a single display area.

In an exemplary embodiment, the first body 100 may include a magnetic material 1030 such as, for example, a magnetic plate, on the outer surface thereof. The two-way hinge 1000 may include a metal material 1040 such as, for example, a metal plate, on a surface contacting the outer surface of the first body 100. As the first body 100 horizontally slides, the magnetic material 1030 and the metal material 1040 move towards each other, as illustrated in FIG. 10B. Once the magnetic material 1030 and the metal material 1040 are aligned, as illustrated in FIG. 10C, the horizontal sliding may be stopped.

The two-way hinge 1000 may include a stopper 1050 blocking the vertical groove 1020, as illustrated in FIGS. 10A-10C, which prevents the first body 100 from vertically sliding while the first body is horizontally sliding. The stopper 1050 may be formed of a metal material having a repulsive force relative to the magnetic material 1030. As the first body 100 horizontally slides, the stopper 1050 moves in the same horizontal direction. When the first body 100 horizontally slides to an ending point, the stopper 1050 enters a stopper hole 1060 formed in the two-way hinge 1000 and connected to the vertical groove 1020, as illustrated in FIG. 10C. Once the stopper 1050 enters the stopper hole 1060, the vertical groove 1020 is unblocked and the first body 100 may descend along the vertical groove 1020. Accordingly, in the third operation mode, the first body 100 descends along the vertical groove 1020 and the upper surface of the first body 100 forms a level surface with the upper surface of the second body 200, as illustrated in FIG. 10D.

The stopper 1050 may include a sub-stopper 1080 at an end portion thereof, protruding upwardly towards the first body 100, as illustrated in FIGS. 10A-10C. The sub-stopper 1080 may be attached to a spring or a similar device. When the stopper 1050 enters the stopper hole 1060, the sub-stopper 1080 enters a gap 1070 formed in the upper portion of the end portion of the stopper hole 1060. Entry of the sub-stopper 1080 into the gap 1070 stops the horizontal sliding of the first body 100.

In another exemplary embodiment, the two-way hinge 1000 is disposed on at least one side surface of an end portion of the first body 100 and horizontally slides along the second body 200 with the first body 100. In this exemplary embodiment, the horizontal groove 1010 and the vertical groove 1020 have a reverse T-shape, contrary to the shape illustrated in FIGS. 10A-10D, and may support the horizontal and vertical movements of the first body 100.

A mobile device comprising the two-way hinge 1000 illustrated in FIGS. 10A-10D is an exemplary embodiment, and the present inventive concept is not limited thereto. For example, a variety of mechanisms including, but not limited to, sliding support devices, fixing devices, and/or stoppers may be employed to enable the mobile device to switch to the third operation mode.

FIG. 6 is a block diagram schematically illustrating the internal structure of a mobile device 10 according to an exemplary embodiment of the present inventive concept. Referring to FIG. 6, the mobile device 10 according to the present exemplary embodiment may include components such as, for example, a control unit or a central processing unit (CPU) 20, a random access memory (RAM) 30, a display unit (Display) 40, a storage unit (Memory) 60, a power supply unit (Power Supply) 70, a communication unit (Communication) 80, and a system bus 50 electrically connecting the components.

The control unit 20 controls the overall operation of the mobile device 10. For example, the control unit 20 may control the components of the mobile device 10 in order to determine the current operation mode and provide appropriate functionality based on the current operation mode. The RAM 30 stores information, such as, for example, an OS program, application programs, and cache data, which are needed for the operation of the mobile device 10.

The display unit 40 may include two touch screen display panels according to an exemplary embodiment of the present inventive concept, as described with reference to FIGS. 1-5.

The storage unit 60 stores application programs and user data. The storage unit 60 may comprise, for example, a flash memory device, however the present inventive concept is not limited thereto. The storage unit 60 may include a memory unit (not shown) and a memory controller (not shown) to control data read/write operations.

The power supply unit 70 supplies power to the components. The power supply unit 70 may receive power from a battery (not shown) and supply the received power to the components. The communication unit 80 is utilized for wireless communications and may include, for example, a modem, a codec, and a transceiving unit.

The mobile device 10 may further include additional components, such as, for example, an antenna, a microphone, a speaker, or a function button. The components of the mobile device 10 may be located within one of the first body 100, the second body 200, or a combination of the first body 100 and the second body 200. Some components such as, for example, the display unit 40 having the two touch screen display panels, the microphone (not shown), the speaker (not shown), or the function button (not shown), may be exposed for user interaction.

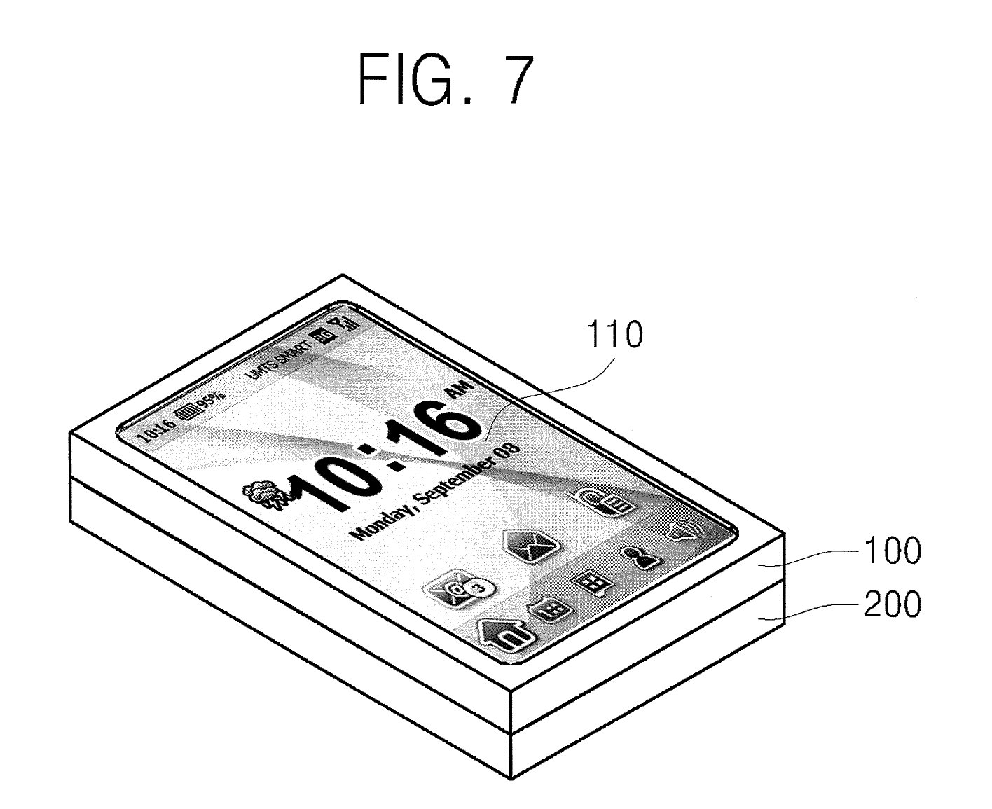

FIGS. 7-9 are perspective views illustrating the service types of the three operation modes of a mobile device according to an exemplary embodiment of the present inventive concept. Referring to FIG. 7, in the first operation mode, the mobile device is operated as a bar type mobile device wherein only the first touch screen 110 is utilized. In the first operation mode, basic service functions such as, for example, general calling, message checking, menu setting, and schedule checking may be provided.

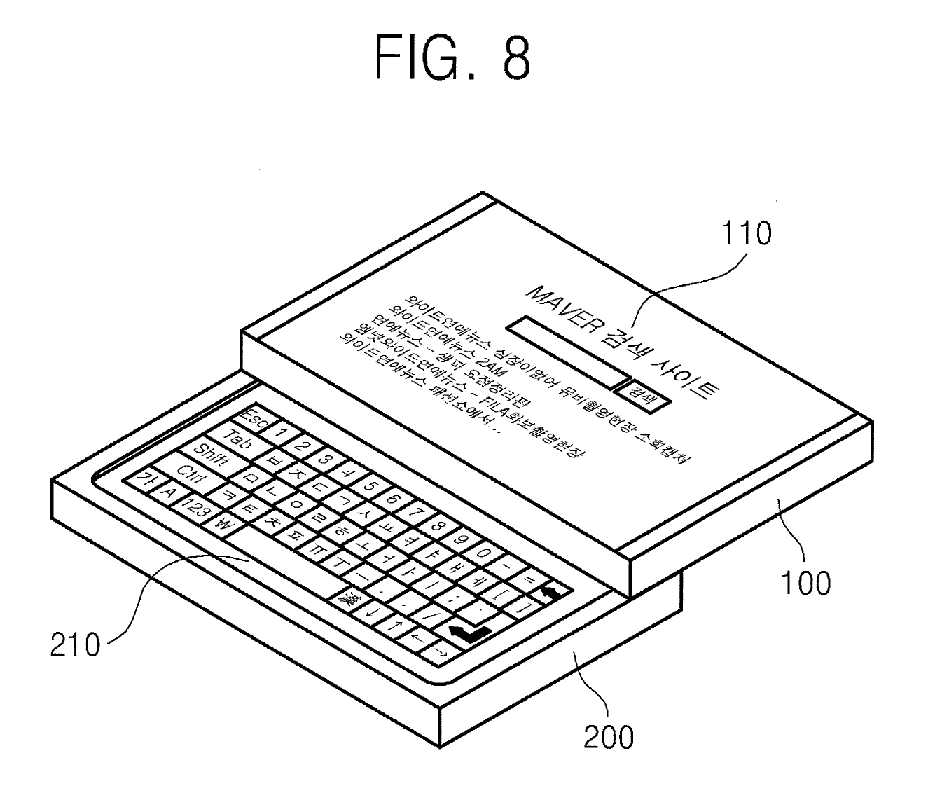

Referring to FIG. 8, in the second operation mode, the first touch screen 110 may function as a screen display area and the exposed area of the second touch screen 210 may function as an input area such as, for example, a QWERTY keyboard. In the second operation mode, service functions requiring text input such as, for example, document editing, messaging, or Internet browsing, may be provided.

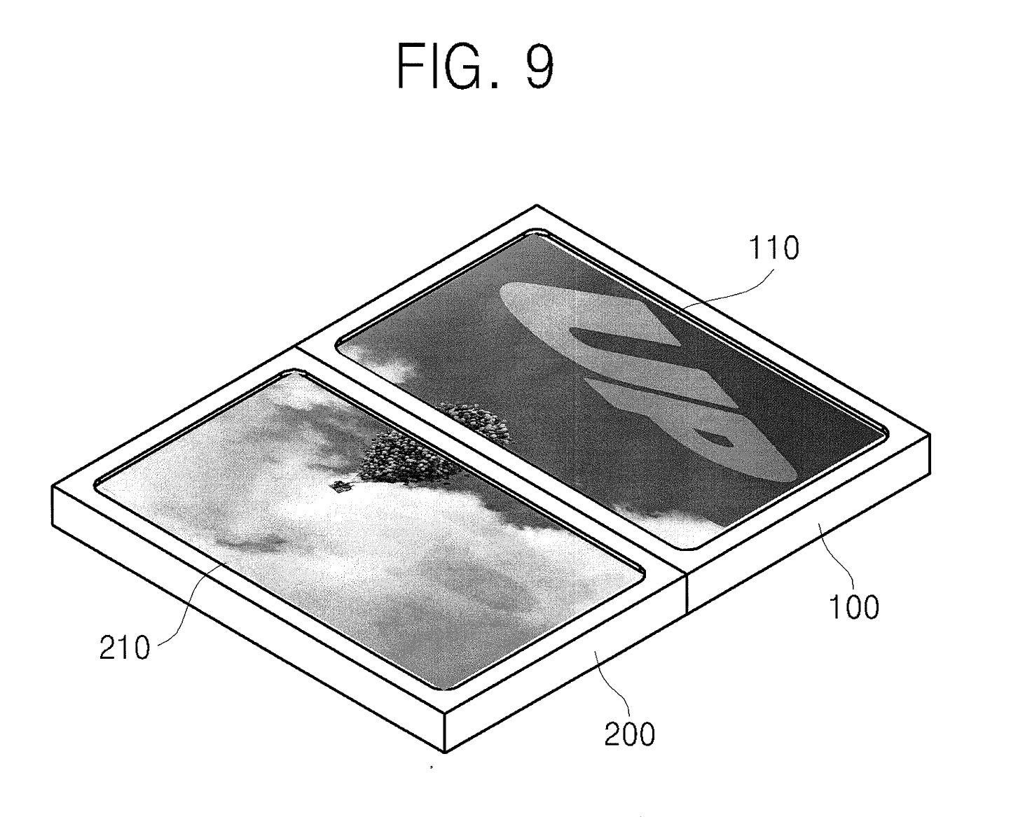

Referring to FIG. 9, in the third operation mode, the first touch screen 110 functions as a first display area of a single screen and the second touch screen 210 functions as a second display area of the single screen. For example, in the third operation mode, the two display areas form a complete single screen. Accordingly, because the third operation mode provides a larger screen than the first and second operation modes, the third operation mode is suitable for displaying video, such as, for example, movies, music videos, or user created content (UCC). The mobile device 10 may function as, for example, a mobile phone, a personal digital assistant (PDA), a digital multimedia broadcasting (DMB) device, a media player, a smart phone, or a portable computer, however the present inventive concept is not limited thereto.

The present inventive concept can be embodied in hardware, software, firmware or a combination thereof.

While the inventive concept has been particularly shown and described with reference to exemplary embodiments thereof, it will be understood that various changes in form and details may be made therein without departing from the spirit and scope of the following claims.

What is claimed is:

1. A mobile device, comprising:
a first body;
a first touch screen disposed on an upper portion of the first body;
a second body disposed under the first body; and
a second touch screen disposed on an upper portion of the second body,
wherein the mobile device is configured to operate in a full-screen mode, wherein the first body is configured to slide in a first direction and a second direction, substantially perpendicular to the first direction, such that the first and second touch screens are adjacent, form a substantially level surface, and function as a single display area while in the full-screen mode.

2. The mobile device of claim 1, wherein the device is configured to operate in a first operation mode, wherein the first body substantially covers the second body and only the first touch screen functions while in the first operation mode.

3. The mobile device of claim 1, wherein the mobile device is configured to operate in a second operation mode, wherein the first body is configured to slide to an ending point such that a partial area of the second touch screen is exposed.

4. The mobile device of claim 3, wherein the first touch screen functions as a display area and the second touch screen functions as a user input area while in the second operation mode.

5. The mobile device of claim 4, wherein the user input area comprises a keyboard.

6. The mobile device of claim 5, wherein the keyboard comprises a QWERTY keyboard.

7. The mobile device of claim 3, wherein the first touch screen functions as a game display area and the second touch screen functions as a game input area comprising game controls while in the second operation mode.

8. The mobile device of claim 1, further comprising:
at least one electrical line disposed on a side surface of an end portion of the first body and a lower portion of the first body; and
at least one electrical groove disposed on a side surface of an end portion of the second body and the upper portion of the second body, wherein the electrical groove engages the electrical line and data is transferred between the first body and the second body via the electrical line and the electrical groove.

9. The mobile device of claim 1, wherein the first body and the second body are configured to be coupled to each other using at least one of a magnetic material, a locking device, a fixing device, or a guard rail.

10. The mobile device of claim 1, further comprising a hinge disposed on at least one side surface of an end portion of the second body, wherein the hinge comprises a horizontal groove and a vertical groove in a T-shape.

11. The mobile device of claim 10, wherein the first body is configured to slide in the first direction along the horizontal groove and slide in the second direction along the vertical groove.

12. The mobile device of claim 11, further comprising:
a magnetic material formed on an outer surface of the first body; and
a metal material formed on a surface of the hinge contacting the outer surface of the first body, wherein
a distance between the magnetic material and the metal material is shortened as the first body slides in the first direction, and
the first body stops sliding in the first direction upon alignment of the metal material and the magnetic material.

13. The mobile device of claim 11, wherein the hinge further comprises:
a stopper hole; and
a stopper, wherein
the stopper blocks the vertical groove and prevents the first body from sliding in the second direction until the first body slides to an ending point in the first direction, wherein the stopper enters the stopper hole and unblocks the vertical groove at the ending point.

14. The mobile device of claim 13, wherein the stopper comprises a sub-stopper protruding towards the first body, wherein the sub-stopper enters a gap formed in the stopper hole upon the stopper entering the stopper hole.

15. The mobile device of claim 14, wherein the sub-stopper is attached to a spring.

16. A method for switching operation modes of a mobile device, comprising:
sliding a first body of the mobile device in a first direction; and
sliding the first body of the mobile device in a second direction, substantially perpendicular to the first direction, upon the first body sliding to a first ending point in the first direction,
wherein a first touch screen disposed on an upper portion of the first body and a second touch screen disposed on an upper portion of a second body are adjacent, form a substantially level surface, and function as a single display area upon the first body sliding to a second ending point in the second direction.

17. The method of claim 16, further comprising transferring data between the first body and the second body via an electrical line disposed on the first body and an electrical groove disposed on the second body.

18. The method of claim 16, further comprising:
sliding the first body in the first direction along a horizontal groove of a hinge; and
sliding the first body in the second direction along a vertical groove of the hinge.
